(19) United States
(12) Patent Application Publication
(10) Pub. No.: US 2016/0327922 A1
(43) Pub. Date: Nov. 10, 2016

(54) A CONTROL DEVICE AND CONTROL METHOD FOR PERFORMING AN OPERATION BASED ON THE CURRENT STATE OF A HUMAN AS DETECTED FROM A BIOMETRIC SAMPLE

(71) Applicant: NIKON CORPORATION, Tokyo (JP)

(72) Inventors: Masakazu SEKIGUCHI, Kawasaki-shi (JP); Motoyuki KUBOI, Yokohama-shi (JP); Toshiaki MAEDA, Yokohama-shi (JP); Kazue MINAGAWA, Kawasaki-shi (JP); Hiromi TOMII, Yokohama-shi (JP)

(73) Assignee: NIKON CORPORATION, Tokyo (JP)

(21) Appl. No.: 15/189,355

(22) Filed: Jun. 22, 2016

Related U.S. Application Data
(63) Continuation of application No. 13/988,900, filed on May 22, 2013, now abandoned.

(30) Foreign Application Priority Data
Jan. 13, 2011 (JP) 2011-005231
Jan. 13, 2011 (JP) 2011-005232
Jan. 13, 2011 (JP) 2011-005236
Jan. 13, 2011 (JP) 2011-005237
Jan. 13, 2011 (JP) 2011-005250
Jan. 13, 2011 (JP) 2011-005251
Jan. 13, 2011 (JP) 2011-005286

(51) Int. Cl. G05B 15/02; H04N 21/422; H04N 21/4223; G06F 3/00; G06F 3/01

(52) U.S. Cl. CPC G05B 15/02; G06F 3/005; G06F 3/012; G06F 3/013; H04N 21/4223; H04N 21/42201

(57) ABSTRACT

There has been a desire for proactively adding more detailed embodiments relating to the acquisition and use of biometric information. Therefore, according to a first aspect of the present invention, for example, provided is an electronic device including an input section that inputs biometric information, which is information relating to a living body of a user; and an output section that outputs a limit signal limiting contact with the user to a bidirectional communication device, based on the biometric information.

This is a continuation application of application Ser. No. 13/988,900 filed May 22, 2013 which claims priority to PCT/JP2011/006932 filed Nov. 16, 2011. The disclosures of the prior applications are hereby incorporated by reference herein in its(their) entirety.

### BACKGROUND

1. Technical Field

The present invention relates to an electronic device and an electronic device control program.

2. Related Art

Recently, proposals have been made to acquire biometric information of a user and provide various types of support, including a proposed audio playing device that detects whether the user is concentrating on the music, and decreases the volume when the user is not concentrating on the music.

### Patent Document 1: Japanese Patent Application Publication No. 2005-34484

However, there has been little added to more specific means of using the acquired biometric information.

### SUMMARY

In order to solve the above problem, according to a first aspect of the innovations of the present invention, provided is an electronic device comprising an input section that inputs biometric information, which is information relating to a living body of a user; and an output section that outputs a limit signal limiting contact with the user to a bidirectional communication device, based on the biometric information.

According to a second aspect of the innovations of the present invention, provided is an electronic device control program that causes a computer to input biometric information, which is information relating to a living body of a user; and output a limit signal limiting contact with the user to a bidirectional communication device, based on the biometric information.

According to a third aspect of the innovations of the present invention, provided is an electronic device comprising a biometric information input section that inputs biometric information, which is information relating to living bodies of a plurality of human targets; and an output section that outputs a control signal for controlling a device to be controlled to the device to be controlled, based on the biometric information.

According to a fourth aspect of the innovations of the present invention, provided is an electronic device control program that causes a computer to input biometric information, which is information relating to living bodies of a plurality of human targets; and output a control signal for controlling a device to be controlled to the device to be controlled, based on the biometric information.

According to a fifth aspect of the innovations of the present invention, provided is an electronic device comprising a time display section that displays time; a first image capturing section that is provided near the time display section; and a first detecting section that detects a frequency with which a face of at least one human target is oriented toward the time display section, based on an image captured by the first image capturing section.

According to a sixth aspect of the innovations of the present invention, provided is an electronic device comprising an input section that inputs biometric information, which is information relating to a living body of a user; a manipulation section that receives input manipulation of the user; a detecting section that detects a manipulation state of the manipulation section resulting from manipulation by the user; and a changing section that changes a setting, based on the manipulation state and change in the biometric information.

According to a seventh aspect of the innovations of the present invention, provided is an electronic device control program that causes a computer to input biometric information, which is information relating to a living body of a user; receive input manipulation of the user through a manipulation section, and detect a manipulation state; and change a setting, based on the manipulation state and change in the biometric information.

According to an eighth aspect of the innovations of the present invention, provided is an electronic device comprising a manipulation section that receives input manipulation of a user; an image input section that inputs an image from an image capturing apparatus capturing at least a portion of the manipulation section and at least a portion of a hand of the user; and a changing section that changes a setting based on position information of the hand acquired by analyzing the image.

According to a ninth aspect of the innovations of the present invention, provided is an electronic device comprising a first manipulation section that receives input manipulation of a user; a second manipulation section that is provided near the first manipulation section and receives the input manipulation; and a changing section that changes manipulation sensitivity of the input manipulation to the second manipulation section, when the input manipulation to the first manipulation section is detected.

According to a tenth aspect of the innovations of the present invention, provided is an electronic device control program that causes a computer to receive input manipulation of a user through a manipulation section; input an image from an image capturing apparatus capturing at least a portion of the manipulation section and at least a portion of a hand of the user; and change a setting based on position information of the hand acquired by analyzing the image.

According to an eleventh aspect of the innovations of the present invention, provided is an electronic device control program that causes a computer to receive input manipulation of a user through a first manipulation section; and change manipulation sensitivity of the input manipulation to a second manipulation section, which is provided near the first manipulation section, when the input manipulation to the first manipulation section is detected.

According to a twelfth aspect of the innovations of the present invention, provided is an electronic device comprising an expression detecting section that detects an expression of a target; a biometric information input section that inputs biometric information, which is information relating to a living body of the target; and a control section that controls a device to be controlled, based on the biometric information and a detection result of the expression detecting section.

According to a thirteenth aspect of the innovations of the present invention, provided is an electronic device control program that causes a computer to detect an expression of a target; input biometric information, which is information relating to a living body of the target; and control a device to be controlled, based on the biometric information and a detection result of the expression detection.

According to a fourteenth aspect of the innovations of the present invention, provided is an electronic device comprising a speaking speed detecting section that detects speaking speed of a target; and a control section that controls a device to be controlled, based on a detection result of the speaking speed detecting section.

According to a fifteenth aspect of the innovations of the present invention, provided is an electronic device control program that causes a computer to detect speaking speed of a target; and control a device to be controlled, based on a detection result of the speaking speed detection.

The summary clause does not necessarily describe all necessary features of the embodiments of the present invention. The present invention may also be a sub-combination of the features described above.

### BRIEF DESCRIPTION OF THE DRAWINGS

FIG. 1 shows an outline of a concentration detection system according to a first embodiment of the present invention.

FIG. 2 is a block diagram of a concentration detection system according to the first embodiment.

FIG. 3 is a flow chart showing a process of the concentration detection system according to the first embodiment.

FIG. 4 is a flow chart showing a process related to detection of a hand of the user, as another application of the first embodiment.

FIG. 5 is a flow chart of a process relating to detection of the speaking speed of the user, as an applied example of the first embodiment.

FIG. 6 shows an outline of a smart phone, which is a modification of the first embodiment.

FIG. 7 is a block diagram of the concentration detection system according to the present modification of the first embodiment.

FIG. 8 shows an outline of a concentration detection system according to a second embodiment.

FIG. 9 is a block diagram of the concentration detection system according to the second embodiment.

FIG. 10 is a flow chart of a process performed by the concentration detection system according to the second embodiment.

FIG. 11 shows an exemplary display in the display viewed by the presenter.

FIG. 12 shows an exemplary display in the display viewed by the presenter.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

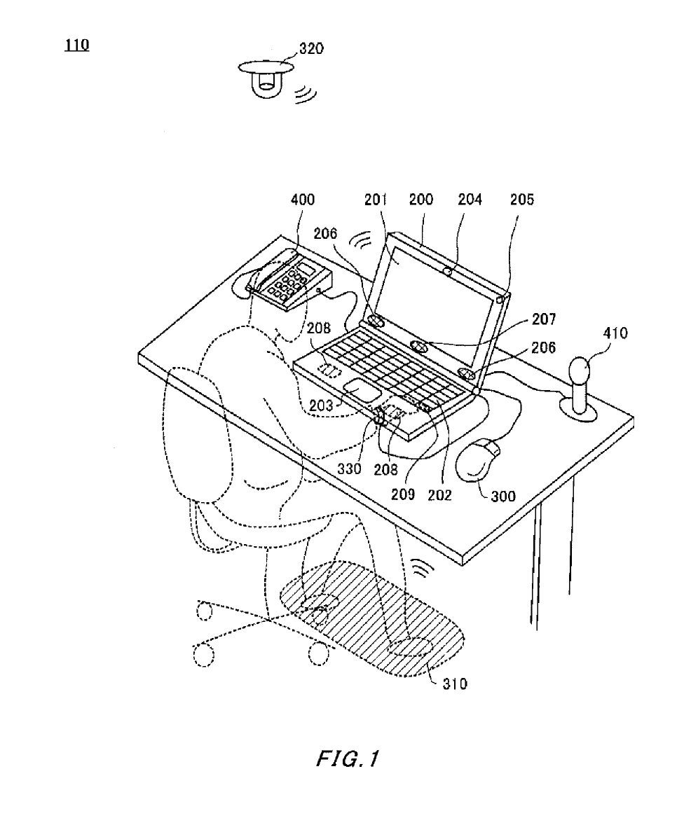

FIG. 1 shows an outline of a concentration detection system 110 according to a first embodiment of the present invention. As shown in FIG. 1, the concentration detection system 110 includes a personal computer (PC) 200 and a biosensor 330 attached to a user. The PC 200 includes user input manipulation sections including a display 201, a keyboard 202, and a touch pad 203. A mouse 300 is connected to the PC 200, and instructions can be provided to the PC 200 by manipulating the mouse 300.

The PC 200 includes an internal camera 204, an ultrasonic sensor 205, a speaker 206, and a microphone 207. The internal camera 204 includes an image capturing lens and an image capturing element. An image sensor such as a CCD sensor or CMOS sensor may be used as the image capturing element. The internal camera 204 is arranged above the display 201, and has an angle of field that enables image capturing of the hands, legs, and face of the user along with the manipulation section such as the keyboard 202 or touch pad 203. Instead of the internal camera 204, a camera module may be attached near the display 201 using a clip or the like. The ultrasonic sensor 205 is provided near the internal camera 204 to send and receive ultrasonic waves for measuring a distance from the display 201 to the user.

A temperature adjusting section 208 is provided in the PC 200 at positions corresponding to where the palms of the user are rested near the left and right of the keyboard 202. The temperature adjusting section 208 includes an electrically heated wire such as a nickel-chromium wire or an iron-chromium wire, and increases in temperature when current flows therethrough. The user can feel a temperature change through the palms.

The back side of the keyboard 202 includes a piezoelectric sensor 209 that corresponds to each key. The piezoelectric sensor 209 includes piezo elements that electrically detect vibration by converting force (pressure) from the outside into voltage via a piezoelectric effect. In this way, the piezoelectric sensor 209 can detect the strength with which the user presses each key and repetitive pressing of keys.

A floor sensor 310 is provided at the feet of the user. The floor sensor 310 may also be formed of piezo elements, like the piezoelectric sensor 209, and detects movement of the feet of the user, such as stepping or twitching. The floor sensor 310 is connected to the PC 200, and transmits detected signals to the PC 200.

A ceiling camera 320 is provided on a ceiling portion that is near a region above the head of the user. The ceiling camera 320 includes an image capturing lens and an image capturing element, and is adjusted to have an angle of field that enables image capturing of the head of the user. The ceiling camera 320 transmits the captured image signal to the PC 200 via wireless LAN, for example. The PC 200 transmits a control signal, such as a request for beginning image capturing or a request for a captured image signal, to the ceiling camera 320.

The biosensor 330 may be wrapped around an arm of the user, for example. The biosensor 330 senses biometric information of the user, and transmits this output to the PC 200. The specific configuration of the biosensor 330 will be described further below.

A phone 400 is connected to the PC 200 as a bidirectional communication device. The phone 400 receives a control signal from the PC, to restrict or allow functions thereof. An indicator light 410 is also connected to the PC 200. The indicator light 410 includes a high-brightness LED that can change the color of the emitted light, for example. The indicator light 410 notifies nearby people of a concentration state of a user determined by the PC 200, by emitting red light, for example.

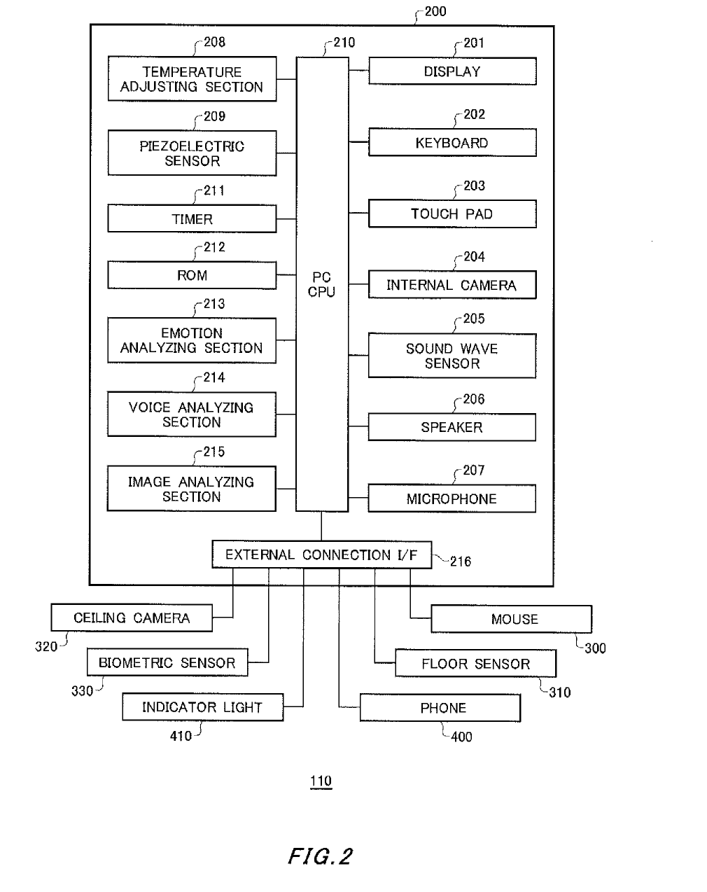

FIG. 2 is a block diagram of a concentration detection system according to the first embodiment. As shown in FIG. 2, the PC 200 is centered on a PC CPU 210 that performs overall control, and also includes the elements described in FIG. 1, such as the display 201, the keyboard 202, and the like.

The timer 211 begins measuring time upon receiving start instructions of the PC CPU 210, and responds to the PC CPU 210 with the time upon receiving end instructions. The ROM 212 is a non-volatile memory such as a flash memory, and stores various parameters and programs for controlling the PC 200, for example. The ROM 212 can also store output of the floor sensor 310, biometric information data, the PC 200 usage state, a user schedule, and various data, for example.

The emotion analyzing section 213 receives biometric information from the biosensor 330, and analyzes the emotion of the user. The biosensor 330 is a sensor that detects biometric information of the user, and includes a pulse sensor that detects a pulse by radiating light from an LED toward a living body and receiving the resulting light reflected from the living body, for example. This configuration is described in Japanese Patent Application Publication No. 2005-270543. In addition to the pulse sensor, the biosensor 330 can be provided with a sweat sensor formed by arranging a plurality of electrodes, in order to detect the amount of sweat of the user. Furthermore, a temperature sensor for measuring body temperature and a blood pressure sensor for measuring blood pressure can be provided.

The emotion analyzing section 213 receives the biometric information from the biosensor 330, and determines the emotion of the user. For example, when a high heart rate and emotional sweat is detected, it can be determined that the user is feeling “rushed.” The relationship between the output of the biosensor 330 and emotions is obtained verifiably, and a table indicating this relationship can be stored in the ROM 212. Therefore, the emotion analyzing section 213 can determine the emotion by checking if the acquired biometric information matches a prescribed emotion pattern recorded in the table. The biosensor 330 is not limited to a wrist watch that is wrapped around an arm of the user, and can adopt any form that results in contact with a portion of the body of the user, such as the hand or finger (e.g. a ring-shaped biosensor). Furthermore, the biosensor 330 can adopt a configuration for detecting the body temperature of the user without contacting the user, such as through thermography. In addition to the biometric information from the biosensor 330, the emotion analyzing section 213 may analyze the emotion by also considering a detection result of the piezoelectric sensor 209 or the floor sensor 310, or may analyze the emotion by also considering an analysis result of the voice analyzing section 214 or the image analyzing section 215, which are described further below.

As another example of the biosensor 330, a pressure sensor and a fluid pouch may be provided in a chair on to detect biometric information of a sitting user. The fluid pouch is a pouch filled with air, for example, that is provided on a chair at a position of the buttocks, in a manner to contact the coccyx or the ischium. The pressure sensor detects the internal pressure of the fluid pouch, and can be a semiconductor sensor or a vibrational pressure sensor that uses piezoelectric elements, for example. with the coccyx or ischium applying pressure to the fluid pouch when the user sits, the pulse of the user it propagated through the fluid bag, thereby changing the internal pressure of the fluid bag and enabling the acquisition of biometric information concerning breathing, heart rate, or the like. Detection of biometric information using a fluid pouch is described in Japanese Patent No. 3906649, for example.

The voice analyzing section 214 analyzes voices acquired by the microphone 207. The voice analyzing section 214 includes a voice recognition dictionary, and can convert the recognized voice into text data to be displayed on the display 201. Some recent computers include voice recognition software installed thereon, and the pre-installed software may be used, or other commercially available software may be installed.

The voice analyzing section 214 works together with the PC CPU 210 to detect the user's conversational speed (speaking speed), loudness of the user's voice, or conversation time for conversations on the phone 400 or conversations with other nearby people, for example. The speaking speed can be detected as a number of output phonemes per unit time, or as a number of “mora” per unit time. A “mora” is a unit of sound in Japanese with a prescribed temporal length.

The image analyzing section 215 analyzes the image signal captured by the internal camera 204 and the image signal captured by the ceiling camera 320. The image analyzing section 215 also performs expression recognition and facial recognition of the user. For example, the image analyzing section 215 detects an expression in which the user's brow is furrowed or an expression in which the user is not smiling and has narrowed eyes, from a facial region of the user in the image signal. The image analyzing section 215 also acquires the time information of the timer 211, and detects how long the expression of the furrowed brow, for example, has continued. Furthermore, when the expression of narrowed eyes is detected, the image analyzing section 215 reads from the ROM 212 information concerning average eye size in an image obtained by the internal camera 204, and compares this average size to the currently captured eye size to detect that the eyes are narrowed. The detection of a furrowed brow may be achieved by storing a reference image of a furrowed brow in the ROM 212 and pattern-matching the current image to this reference image, or by detecting shadow distribution between the left and right eyes. Detection of a furrowed brow is described in US Patent Application Publication No. 2008-292148, for example.

The size of the image capture by the internal camera 204 depends on the distance between the user and the internal camera 204. In the present embodiment, the distance between the internal camera 204 and the user is detected by the ultrasonic sensor 205, and the distance dependency is eliminated by correcting the size of the image. The distance measurement is not limited to being realized by the ultrasonic sensor 205, and instead a laser distance sensor or an infrared distance sensor may be used, for example. Furthermore, if the size of a prescribed portion of a user, such as the size of the face, is known, the distance between the internal camera 204 and the user can be calculated by matching the known size of the face to the size of the face in the captured image.

The image analyzing section 215 acquires the image signal of the ceiling camera 320, and detects the movement amount, position, or the like of the head of the user. For example, if the image analyzing section 215 detects that the head of the user is moving back and forth constantly, the PC CPU 210 can determine that the user has very low concentration or is nodding off, for example. If the movement amount or position of the head of the user can be detected by the ultrasonic sensor 205 or the like, the ceiling camera 320 may be omitted. On the other hand, if the distance between the user and the internal camera 204 can be detected by the ceiling camera 320, the ultrasonic sensor 205 may be omitted.

The external connection interface 216 is an interface for connecting with an external device. The interface can adopt a variety of connection standards, such as wireless or wired LAN, USB, HDMI (registered trademark), or Bluetooth (registered trademark). For example, the phone 400 may be connected to the PC 200 via the external connection interface 216, and when the concentration amount of the user is greater than a predetermined threshold, as described further below, the PC CPU 210 may transmit to the phone 400 a control signal to reject calls. At this time, in parallel, the PC CPU 210 transmits to the indicator light 410 a control signal causing the indicator light 410 to emit light indicating that the user is concentrating. When this concentration state has continued for a prescribed time, the PC CPU 210 issues a command to raise the temperature of a temperature adjusting section housed in the mouse 300, for example.

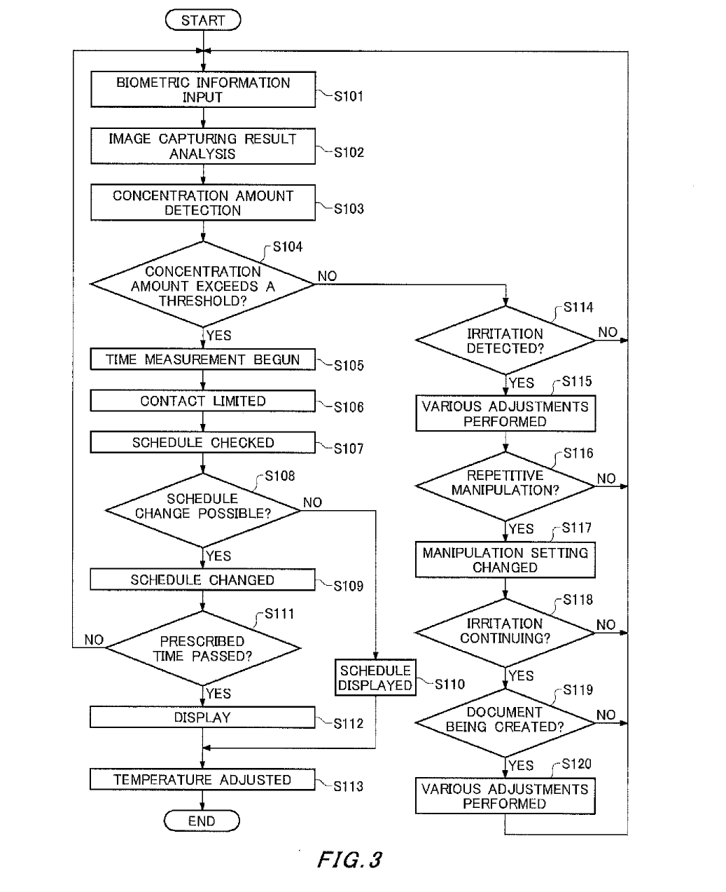

FIG. 3 is a flow chart showing a process of the concentration detection system according to the first embodiment. In this process flow, the PC CPU 210 exerts control to detect the concentration amount, expression, or the like of the user and perform a process corresponding to the detection result. In this process flow, it is imagined that the user is manipulating the PC 200.

The PC CPU 210 inputs information relating to the living body of the user (step S101). Specifically, the PC CPU 210 inputs biometric information such as the pulse, body temperature, or sweat amount of the user detected by the biosensor 330, or the speaking speed or speaking volume of the user, twitching of the user, or keyboard 202 typing strength or speed of the user detected by the piezoelectric sensor 209, for example. The biometric information concerning the living body is not limited to the information acquired by the biosensor 330, as described above. Furthermore, the PC CPU 210 need not input all of these types of biometric information, and need only input enough biometric information to enable detection of the concentration amount.

The PC CPU 210 stores the input biometric information of the user in the ROM 212, and records a log of the user biometric information. The PC CPU 210 detects the concentration amount of the user as described further below, using the biometric information stored in the ROM 212. There may be cases in which the PC 200 is shared by a plurality of users. In such a case, the PC CPU 210 identifies the face of the user with the internal camera 204, and records a log of the biometric information for each user.

Next, the PC CPU 210 captures images with the internal camera 204 and the ceiling camera 320, and detects the expression of the user with the image analyzing section 215 (step S102).

The PC CPU 210 analyzes whether the user has a furrowed brow or narrowed eyes, for example. When there is such an expression, the PC CPU 210 estimates that the image in the display 201 is difficult to see. When the eyes of the user are narrowed, the PC CPU 210 uses the ultrasonic sensor 205 to detect the distance from the display 201 to the user. The PC CPU 210 determines that concentration is low when the eyes are narrowed, and that concentration is high when there is little change in an expression other than the narrowed eye expression. When performing this analysis, the analysis accuracy can be improved by, in addition to the expression analysis, also considering the emotion of the user (rushed, irritated, etc.) based on the biometric information acquired at step S101.

The image analyzing section 215 detects the movement amount of the head of the user, from the image signal of the ceiling camera 320. When the user is concentrating, there is little movement of the head, and when the user is not concentrating, there is a large amount of head movement. The order in which steps S101 and S102 are performed may be switched.

The PC CPU 210 proceeds to step S103, and detects the concentration amount of the user by using the results of steps S101 and S102. People generally have increased pulse and body temperature when concentrating. Furthermore, when performing an urgent task (i.e. when concentration is high), people might press the keyboard 202 strongly and quickly, or start twitching their legs. Furthermore, when talking on the phone 400, for example, people might speak quickly or with a loud voice. While there is little head movement when a person is concentrating, when a person is not concentrating, they look to the sides or sometimes move their head a large amount when nodding off, for example. Therefore, in the concentration detection system 110 of the present embodiment, the PC CPU 210 detects the concentration amount of the user by comparing the biometric information of the user stored in the ROM 212 to the biometric information input at step S101. In this case, the PC CPU 210 may detect the concentration amount by comparing the biometric information at a time in the past when the user was concentrating to the biometric information input at step S101, or by determining that the user is concentrating when the pulse or keyboard 202 pressing strength of the user is 10% or more greater than when the user is in a normal state.

Concerning the leg twitching, there can be cases where it occurs when the user is concentrating and cases where it occurs when the user is not concentrating. For such cases, the PC CPU 210 determines, for each user, whether the user is the type of person that twitches their leg when concentrating, from other biometric information, and then uses this information for future concentration determinations.

The PC CPU 210 proceeds to step S104, and determines whether the concentration amount of the user acquired at step S103 exceeds a predetermined threshold. In the present embodiment, a threshold is set for each user, and is set based on concentration data for the user stored in the ROM 212. For example, the PC CPU 210 may set the threshold to be 10% greater than the biometric information indicating the average concentration amount at a normal time in the past, as described above. As another example, the PC CPU 210 may set the threshold to be the concentration amount occurring at a time when biometric information indicating an irritated emotion was detected, such as when the phone rang or someone spoke while the user was concentrating. The PC CPU 210 uses the emotion analyzing section 213 to determine the irritated emotion by matching values such as heart rate and blood pressure with the pattern of an emotion indicating irritation recorded in the table, as described above.

The PC CPU 210 proceeds to step S114 when it is determined that the user has an average amount of concentration, and proceeds to step S105 when it is determined that the user has a high amount of concentration. First, a case in which the concentration amount does not exceed the threshold will be described.

The PC CPU 210 proceeds to step S114 and determines whether the user is irritated, by using the results of steps S101 and S102. The PC CPU 210 uses the emotion analyzing section 213 to determine the irritated emotion by matching values such as heart rate and blood pressure with the pattern of an emotion indicating irritation recorded in the table. In order to make a more accurate determination, the PC CPU 210 can also use the expression of the user analyzed by the image analyzing section 215, the leg twitching of the user detected by the floor sensor 310, the speaking volume detected by the voice analyzing section 214, or the like. In particular, concerning the expression of the user, the user can be determined to be in the irritated state when an unhappy expression, such as a furrowed brow and narrowed eyes without a smile, is detected and the speaking volume is high.

The PC CPU 210 proceeds to step S115 when the user is determined to be irritated, and returns to step S101 when the user is determined to not be irritated. At step S115, the PC CPU 210 performs various adjustments.

Specifically, the PC CPU 210 changes a setting for response speed to keyboard 202 input. Here, the feeling of irritation is estimated to be caused by slow response speed of the keyboard 202, and the setting is changed to increase the response speed. As another example, when the user is detected to have narrowed eyes, the PC CPU 210 estimates that this is caused by the display being small, and changes the setting concerning the size of characters, images, or icons displayed in the display 201 to increase the size.

When increasing the response speed of the keyboard 202, the PC CPU 210 may use software to change the setting such that the response speed (sensitivity) of the touch pad 203 is decreased when the user performs manipulation of the keyboard 202. With this setting, unintentional operations occurring when the hand or nearby portion of the user inadvertently contacts the touch pad 203 can be prevented.

When increasing the size in the display 201, the PC CPU 210 may change the size setting according to the detection result of the ultrasonic sensor 205. If the user is irritated even when the keyboard 202 is not being manipulated, the user may be irritated because the display 201 entered an energy-saving mode or started a screen-saver against the intent of the user. When the user is irritated in such a case, the PC CPU 210 changes the settings to increase the time before the display 201 transitions to the energy saving or screen-saver mode, or to forbid such a transition. It is not necessary to perform all of the above processes as the adjustments of step S115, and only suitable processes should be selected and implemented. The accuracy of the determination made when the user is irritated or thinking carefully can be improved by using a plurality of analyzing sections such as the emotion analyzing section 213 and the image analyzing section 215.

Next, the PC CPU 210 proceeds to step S116, and determines whether the manipulation state of the keyboard 202 is a prescribed repetitive manipulation or continuous manipulation. If the same key, such as the “back space” key or “delete” key, is being pressed repeatedly, or if a key is being pressed continuously despite being ineffective, the PC CPU 210 determines that the input manipulation of the keyboard 202 is not progressing well. When it is determined that the input manipulation is not progressing well, the PC CPU 210 proceeds to step S117, and when such a determination is not made, the PC CPU 210 returns to step S101.

Upon reaching S117, the PC CPU 210 changes the input manipulation setting from the keyboard 202 to audio input using the microphone 207. The PC CPU 210 also displays in the display 201 notification of this manipulation setting change. Obviously, the PC CPU 210 may acquire permission for this change from the user prior to changing the manipulation setting.

As another example, when it is determined that repetitive manipulation or continuous manipulation is for the order of character conversion candidates for Chinese character conversion, the PC CPU 210 may overwrite the file defining this order to change the order in which these candidates are displayed in the display 201. Furthermore, the PC CPU 210 may change the conversion input from Roman characters to Japanese characters, or may change the original setting for inputting Roman characters and Arabic numerals from full-width characters to half-width characters. Yet further, the PC CPU 210 can nullify the learning function during the period when the repetitive manipulation or continuous manipulation is performed.

The PC CPU 210 proceeds to step S118 and uses the emotion analyzing section 213 to determine whether the user is continuing to feel irritated. The PC CPU 210 proceeds to step S119 if it is determined that the feeling of irritation is continuing, and returns to step S101 is the feeling of irritation has gone away.

The PC CPU 210 proceeds to step S119 and determines whether the user is creating a document, such as an e-mail. The PC CPU 210 proceeds to step S120 if it is determined that the user is creating a document, and returns to step S101 if it is determined that the user is not creating a document.

When the user is irritated and creating a document such as an e-mail, there are cases where the user has a pained expression or is using hurtful or inappropriate words, which the user would regret later. Therefore, in the present embodiment, such inappropriate phrases are stored in the ROM 212 together with acceptable phrases to replace these inappropriate phrases, and when the user uses the inappropriate phrases while in an irritated state, the PC CPU 210 changes these phrases to the acceptable phrases.

In the case of an e-mail that is not urgent, the PC CPU 210 may prevent immediate transmission of the e-mail and inquire about the acceptability of the phrases used, at a time when the irritation of the user has subsided. In this way, damage to personal relationships can be prevented.

When the PC CPU 210 detects an inappropriate phrase, this phrase is displayed in the display 201. If the user is having a conversation through video by using a television phone function of the PC 200, the PC CPU 210 can stop the transmission of video or modify fast speech by changing the frequency of the conversation. Instead of stopping the video, the PC CPU 210 may perform image processing such as lowering the number of transmitted pixels. At step S120, when performance of the various adjustments has ended, the PC CPU 210 returns to step S101.

Next, a case in which it is determined at step S104 that the concentration value exceeds the threshold will be described.

Upon reaching step S105, the PC CPU 210 starts the time measurement of the timer 211. Based on the time measurement begun at step S105, the PC CPU 210 acquires the time during which the high concentration state of the user continues. Based on this time measurement, data indicating how long the high concentration state of the user is maintained can be extracted. In the present embodiment, if the high concentration state continues for a predetermined period, e.g. 90 minutes, the user is notified that the high concentration state has been continuing for a long time, as described further below.

Next, at step S106, the PC CPU 210 limits contact with the user. In particular, the PC CPU 210 transmits a limit signal limiting contact requests to the bidirectional communication device through which a third party requests contact with the user. Here, the phone 400 is used as an example of the bidirectional communication device.

The PC CPU 210 transmits to the phone 400 a control signal that sets the phone 400 to an away mode in which the phone 400 does not ring. The phone 400 receives this control signal, sets the call volume to 0, and enters the away mode. When contact from a third party is received while in the away mode, the phone 400 plays a message concerning the state of the user and a request for contact by mail or to call again. Furthermore, the phone 400 can be set to ask the caller how important the call is, instruct the caller to press the numeral 1 if the call is urgent, and inform the user of the call only in this case.

The bidirectional communication device is not limited to an external device. If the PC 200 includes a television phone function, contact requests to the television phone function are restricted. Furthermore, contact requests to a mail function provided as software of the PC 200 may be limited. For example, if the setting during a normal time is such that a pop-up widow is shown and an alert is issued when mail is received, this setting is limited to only opening a pop-up window when the user is concentrating. Furthermore, the setting can be such that mail is not received when the user is concentrating. When limiting contact requests to the bidirectional communication device, the display 201 may provide notification so that the user can be aware of this limitation.

Furthermore, the transmission of the control signal limiting contact with the user is not limited to the bidirectional communication device, and the control signal can be transmitted to a variety of controlled devices. The present embodiment describes control for the indicator light 410.

The indicator light 410 expresses whether contact to the user is permitted, based on the color of the emitted light, as described above. For example, red light means that contact with the user is prohibited, and a blue light means that contact with the user is allowed. At step S106, the PC CPU 210 transmits the control signal instructing emission of red light to the indicator light 410. The indicator light 410 receives the control signal, and emits red light. In this way, people around the user can understand that the user is concentrating and cannot be contacted.

In addition to or instead of the indicator light 410, the control signal can be transmitted to a liquid crystal controllable partition that surrounds the user. The PC CPU 210 can control the partition to be in a non-transparent state when the user is concentrating, and in a transparent state at normal times. Furthermore, the PC CPU 210 can transmit a control signal to begin sound cancellation to a sound cancelling apparatus that eliminates noise by generating sound waves with a phase inverse to that of the noise in the surrounding environment. Yet further, the PC CPU 210 can transmit, to a key control apparatus, a control signal to lock the room of the user.

The PC CPU 210 proceeds to step S107 and checks the schedule of the user to determined whether there is any task other than desk work, such as a meeting, in the near future. If such an event is in the schedule, the PC CPU 210 determines whether this schedule can be changed (step S108). For example, if there is a meeting, the PC CPU 210 makes the determination based on whether a superior is among the participants at the meeting, whether attendance of the user is required at the meeting, and whether the meeting is urgent. If attendance of the user is not required, or if attendance is required but the meeting is not urgent and no superiors are participating, for example, the PC CPU 210 determines that the schedule can be changed. On the other hand, if the meeting is urgent, attendance is required, and a superior will also participate, the PC CPU 210 determines that the schedule cannot be changed. The standards for this determination are set in advance and recorded in the ROM 212 as a lookup table.

The PC CPU 210 proceeds to step S109 if the determination at step S108 is “YES,” and proceeds to step S110 if the determination at step S108 is “NO,” Upon reaching step S109, the PC CPU 210 sends an e-mail to the presenter and the participants in the meeting, automatically informing these people that the user cannot attend the meeting. Furthermore, the PC CPU 210 notifies the user by displaying a notification of the meeting cancellation in the display 201.

Next, the PC CPU 210 determines whether 90 minutes have passed from when time measurement was begun at step S105 (step S111). The PC CPU 210 returns to step S101 if 90 minutes have not passed, and proceeds to step S112 if 90 minutes have passed. At step S112, the PC CPU 210 displays a warning in the display 201 that the high concentration state is continuing for a long time.

The warning displayed at step S112 must be more noticeable than the display performed for the meeting cancellation at step S109. Accordingly, the PC CPU 210 displays this warning as a larger image, for a longer time, or in a flashing manner, compared to the display of the meeting cancellation at step S109.

Furthermore, the PC CPU 210 proceeds to step S113 and warms the palms of the user by applying current to the temperature adjusting section 208, thereby drawing the user's attention to the warning through physical sensation. If use of the mouse 300 is detected, the current may be added to the temperature adjusting section housed in the mouse 300. Furthermore, the PC CPU 210 may lower the surrounding temperature by transmitting a control signal instructing cooling to an air conditioner apparatus.

On the other hand, if the determination at step S108 is “NO,” the PC CPU 210 proceeds to step S110 and attracts the user's attention by displaying notification of the meeting that will be held in the display 201, five minutes before the meeting begins, for example. In this case, the displayed notification may be displayed as a larger image, for a longer time, or in a flashing manner, compared to the display of the meeting cancellation at step S109. Furthermore, the PC CPU 210 proceeds to step S113 described above, and uses the temperature adjusting section 208 to make the user aware of the scheduled meeting through physical sensation.

Through the series of processes described above, when the user exits the high concentration state, a process to remove the contact limitation is performed, and the process flow is ended. In the above process flow, the period during which the contact limitation is performed is set to be a period during which high concentration is maintained, until a warning is issued or until a scheduled item is begun, but the period of contact limitation is not limited to this. For example, the user may set in advance a period during which the user wants to concentrate. With this configuration, the user can cut off contact with the outside through the user's own volition. Furthermore, the PC CPU 210 can extract an average concentration period that can be maintained for each user from past logs, and set this as the contact limitation period. When this configuration is adopted, the period can be controlled based on the characteristics of each user.

In the above embodiment, the expression of the user is detected by the internal camera 204 capturing an image of the face of the user. Instead of this, or in addition to this, movement of a hand of the user can be used as a determination factor. For example, reference images of hands corresponding to various movements can be prepared in advance, and movement of the hand can be identified by the image analyzing section 215 performing pattern matching with the image captured by the internal camera 204.

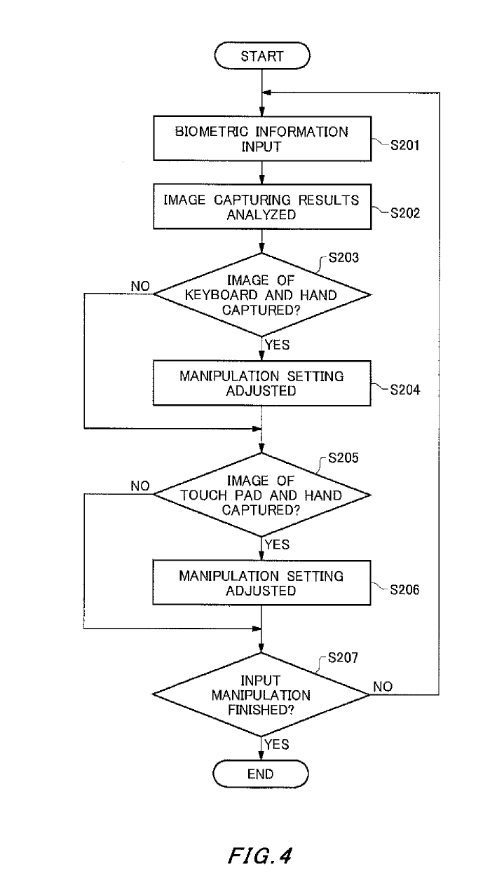

FIG. 4 is a flow chart showing a process related to detection of a hand of the user, as another application of the first embodiment. Specifically, FIG. 4 is a flow chart of detection of a hand of the user and a process corresponding to the detected hand, under the control of the PC CPU 210. Here, the term “hand” refers to not only the actual hand, but also to the wrist and regions of the arm near the wrist.

Step S201 is a process for inputting biometric information, and is substantially the same as the process of step S101 described above. Step S202 is a process for analyzing image capturing results, and is substantially the same as the process of step S102 described above. Accordingly, descriptions of these processes are omitted.

At step S203, the PC CPU 210 determines whether the keyboard 202 and the hand of the user are included in the image signal obtained by the image capturing of the internal camera 204, based on the analysis result of the image analyzing section 215. Specifically, the image analyzing section 215 analyzes whether at least a portion of the keyboard 202 and at least a portion of a hand are overlapping. The image analyzing section 215 may then analyze whether the overlapping hand is the right hand or left hand, and whether the hand also overlaps the mouse 300. The image analyzing section 215 transmits to the PC CPU 210, as the analysis result, position information including the relative position relationship between the hand of the user and the keyboard 202. The PC CPU 210 can predict the manipulation that will be performed by the user, even before the user actually manipulates the keyboard 202 or the like, based on the position information transmitted from the image analyzing section 215. Based on the received position information, the PC CPU 210 proceeds to step S204 if it is determined that the keyboard 202 and the hand are overlapping, and skips step S204 to proceed to step S205 if it is determined that the hand and the keyboard 202 are not overlapping.

At step S204, the PC CPU 210 adjusts the manipulation section setting. Specifically, the PC CPU 210 changes the response speed of the keyboard 202 and the touch pad 203. Here, the “response speed” includes the concept of key touch sensitivity, i.e. whether a response occurs at a slight touch or whether a firm touch is necessary to generate a response. Here, since the keyboard 202 and the hand of the user overlap, it is predicted that the user intends to manipulate the keyboard 202, and therefore the PC CPU 210 reduces the response speed (sensitivity) of the touch pad 203, which is the adjacent manipulation section. In other words, the touch pad 203 is set to respond only to a firm touch. Instead, the PC CPU 210 may change the setting such that the touch pad 203 does not receive any input manipulation. In this way, unintentional operations occurring when the hand or nearby portion of the user inadvertently contacts the touch pad 203 can be prevented. Concerning the determination as to which setting should be changed to, the PC CPU 210 can adopt conditions such as whether both the right and left hands are overlapping the keyboard 202, for example.

As another setting change condition, the biometric information acquired at step S201 may be considered. For example, when the emotion analyzing section 213 detects that the user is irritated, the PC CPU 210 may change the setting such that the response speed for input to the keyboard 202 increases. Furthermore, the amount of change in the response speed may correspond to how irritated the user is. In this case, a plurality of speeds, e.g. 2 to 4 stages of settings, are prepared in advance. When the adjustment of the manipulation section setting is finished, the PC CPU 210 proceeds to step S205.

Next, at step S205, the PC CPU 210 determines whether the touch pad 203 and the hand of the user are included in the image signal obtained by the image capturing of the internal camera 204, based on the analysis result of the image analyzing section 215. The PC CPU 210 can predict the manipulation that will be performed by the user, even before the user actually manipulates the touch pad 203 or the like, based on the position information transmitted from the image analyzing section 215. Based on the received position information, the PC CPU 210 proceeds to step S206 if it is determined that the touch pad 203 and the hand are overlapping, and skips step S206 to proceed to step S207 if it is determined that the hand and the touch pad 203 are not overlapping.

At step S206, the PC CPU 210 adjusts the manipulation section setting. Specifically, the PC CPU 210 changes the response speed of the keyboard 202 and the touch pad 203. More specifically, if the response speed of the touch pad 203 was decreased or the touch pad 203 was set to not receive the input manipulation by the adjustment at step S204, the PC CPU 210 returns this setting to the original setting. In particular, if it is determined that the hand of the user does not overlap the keyboard 202, the PC CPU 210 may return the setting to the original setting. Furthermore, if the touch pad 203 is being manipulated continuously, the PC CPU 210 may increase the response speed of the touch pad 203. Furthermore, as a setting change condition, the biometric information acquired at step S201 may also be considered. For example, when the biometric information is considered and the response speed of the keyboard 202 is increased, the setting of the touch pad 203 only can be changed while maintaining the setting of the keyboard 202. When the adjustment of the manipulation section setting is finished, the PC CPU 210 proceeds to step S207.

At step S207, the PC CPU 210 determines whether the input manipulation by the user is finished. Specifically, the PC CPU 210 determines that the input manipulation is finished if no input to the keyboard 202 or touch pad 203 is detected for a predetermined time. The PC CPU 210 returns to step S201 when it is determined that the input manipulation is continuing, and the series of processes is ended when it is determined that the manipulation input is finished.

In the above process flow, the internal camera 204 captures an image of the hand of the user, the keyboard 202, and the touch pad 203, but this image may be captured by the ceiling camera 320 instead. The above flow describes an example in which it is assumed that the user operates the touch pad 203, but if the user operates the mouse 300 instead, the settings for the touch pad 203 described above can be applied to the mouse 300 instead. In this case, the PC CPU 210 may set the touch pad 203 to have reduced response speed or to not receive input.

In the above flow, the internal camera 204 captures an image of the hand of the user, the keyboard 202, and the touch pad 203 to obtain the position information, but instead, the manipulation section setting may be changed after receiving the actual input manipulation, and an image signal need not be used. Since the setting of the manipulation section is changed after the actual input manipulation is detected, a slight time lag occurs, but the processing load of the image analyzing section 215 can be decreased. This is particularly effective when changing the manipulation sensitivity of the touch pad 203.

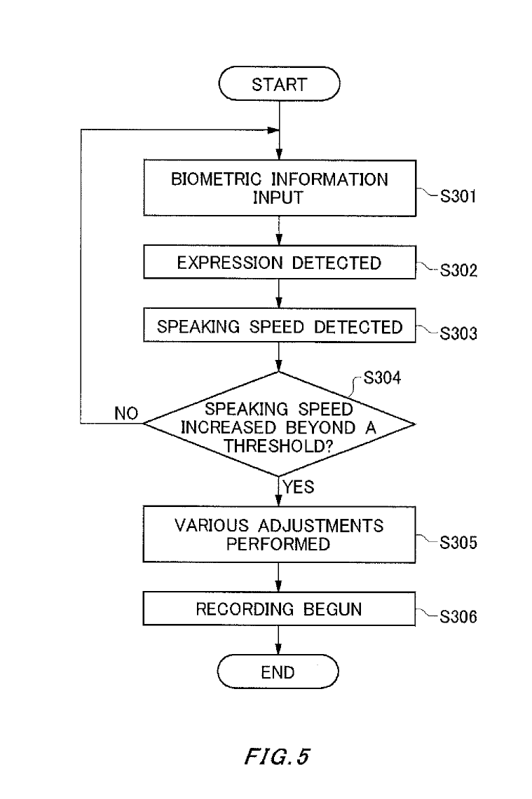

The following describes an example of the voice analyzing section 214 in applied use. FIG. 5 is a flow chart of a process relating to detection of the speaking speed of the user, as an applied example of the first embodiment. Here, it is assumed that the user uses a television phone as a function of the PC 200.

Step S301 is a process for inputting biometric information, and is substantially the same as the process of step S101 described above, and therefore description of this process is omitted. At step S302, the PC CPU 210 uses the image analyzing section 215 to analyze the image signal from the internal camera 204 and detect the expression of the user. Furthermore, the PC CPU 210 determines the mood of the user from the expression of the user.

The PC CPU 210 proceeds to step S303, and uses the voice analyzing section 214 to analyze the audio signal from the microphone 207 and detect the speaking speed of the user. Specifically, the voice analyzing section 214 calculates the speaking speed by counting the number of output sounds per unit time.

Next, at step S304, the PC CPU 210 determines whether the speaking speed exceeds a predetermined threshold. In other words, the PC CPU 210 tracks the time at which the user begins to feel agitated, by utilizing the natural phenomenon that speaking speed increases drastically at the initial stage of agitation. For example, the PC CPU 210 can continuously monitor the speaking speed at normal times, record this speaking speed in the ROM 212, and set a threshold that is 20% greater than the recorded speaking speed at normal times. A threshold can be set for each user by identifying each user through facial recognition techniques or the like.

The PC CPU 210 can consider the information from at least one of step S301 and step S302 as a determination condition. For example, even when the speaking speed exceeds the threshold, if it is determined by the expression detection that the user is in a good mood, the PC CPU 210 does not determine that the speaking speed is increased. Furthermore, the PC CPU 210 can add, as conditions for determining that the speaking speed has increased, the detection of a negative emotion such as “agitation,” “irritation,” or “feeling rushed” based on the biometric information. A combination of these types of information can be determined all together with weighting applied to each detection result.

The PC CPU 210 returns to step S301 when it is determined that the increase amount in the speaking speed is less than the threshold, and proceeds to step S305 when it is determined that the increase amount in the speaking speed exceeds the threshold.

Upon reaching step S305, the PC CPU 210 performs a variety of adjustments. First, the PC CPU 210 notifies the user that the user is speaking quickly, thereby informing the user of their agitated state. Specifically, the PC CPU 210 decreases the brightness of the display 201. Instead, the PC CPU 210 may display text or an image with a message in the display 201 to directly inform the user.

Furthermore, the PC CPU 210 can transmit a control signal to an external device and cause the external device to notify the user. Specifically, the PC CPU 210 may transmit a control signal to the indicator light 410 that causes the LED to flash. The PC CPU 210 may transmit a control signal to an illumination device arranged in the room of the user, to change the brightness of the illumination device and thereby change the brightness of the room. As another example, the PC CPU 210 may decrease the audio output of a television or music played near the user.

When the user is agitated, it is expected that damage to the personal relationships of the user can be prevented by the PC CPU 210 proactively limiting the communication through the television phone. Specifically, the PC CPU 210 can stop or change the video of the conversation partner in the television phone. Furthermore, the transmitted voice of the user can be processed. For example, the frequency can be changed such that the voice sounds quieter. As another example, the PC CPU 210 may degrade the communication quality of the television phone, and eventually cut off the communication.

The PC CPU 210 proceeds to step S306, and begins recording at least one of the image signal from the internal camera 204 and the audio signal from the microphone 207. The image signal from the ceiling camera 320 may be recorded. In this way, by recording the environment around the user including the user when the user is agitated, a record of the conversation can be recorded to assist with the user's memory. Furthermore, when the user has returned to a normal state, the user can objectively reflect on their own actions.

The first embodiment above describes the concentration detection system 110 with manipulation of a PC 200 as an example. Instead, the concentration detection system 110 may be adopted for manipulation of a smart phone.

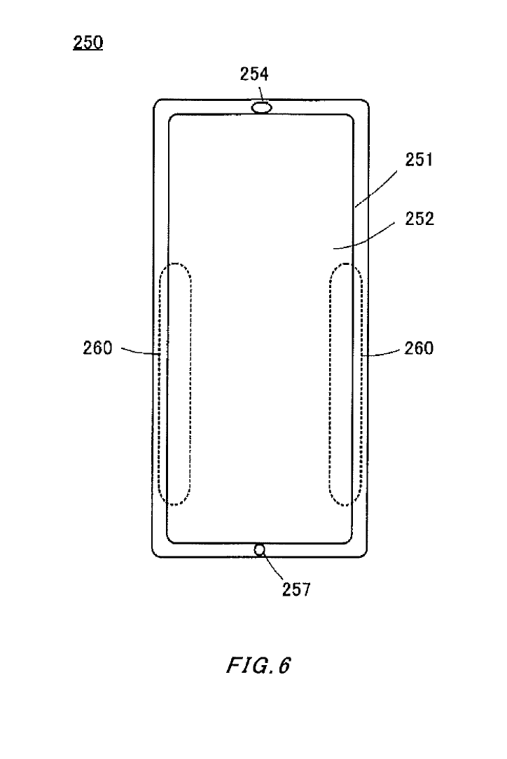

FIG. 6 shows an outline of a smart phone 250, which is a modification of the first embodiment. As shown in FIG. 6, the smart phone 250 has a rectangular shape and includes a display 251, a touch panel 252 provided on the surface of the display 251, an internal camera 254, a microphone 257, and a biosensor 260.

The touch panel 252 can receive a variety of instructions, as a result of the user touching the surface of the display 251. The internal camera 254 is arranged on the same surface as the touch panel 252, and includes an image capturing lens and an image capturing element. In addition to the internal camera 254, another internal camera may be provided on the surface opposite the touch panel 252.

The microphone 257 is provided at the bottom to easily face the mouth of the user when the user holds the smart phone 250. The biosensor 260 is provided on the long side surface, in order to contact the hand of the user when the user holds the smart phone 250. The biosensor 260 may be provided on the smart phone 250 itself, or a biosensor 330 formed as a wrist watch may be used, such as described above in the first embodiment.

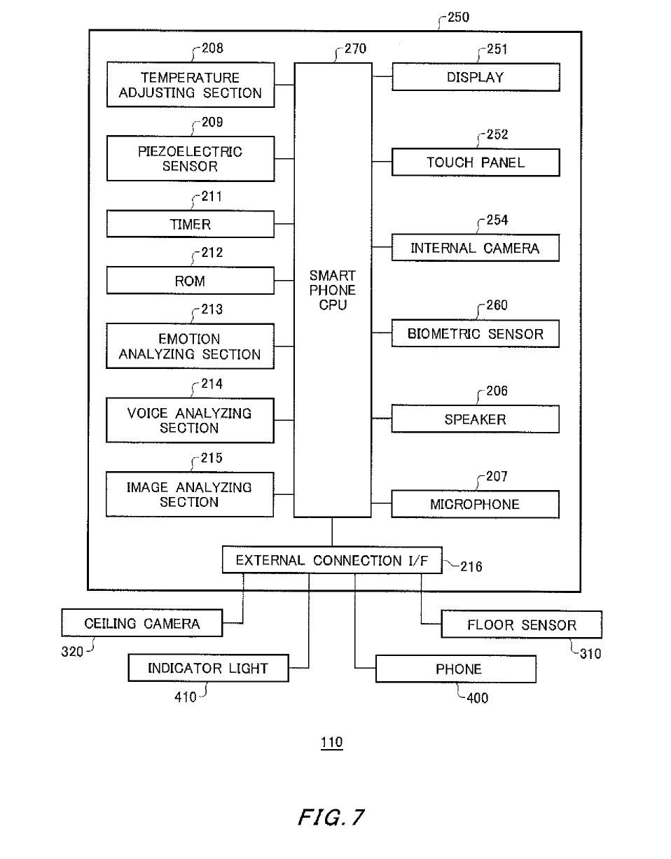

FIG. 7 is a block diagram of the concentration detection system 110 according to the present modification of the first embodiment. Aside from the configuration described in FIG. 6, the configuration of this concentration detection system 110 is practically the same as the configuration shown in the block diagram of FIG. 2, and therefore the same reference numerals are used and redundant descriptions are omitted. The smart phone CPU 270 is a control apparatus that performs overall control of the smart phone 250.

In the present modification as well, the smart phone CPU 270 limits contact with the user when the user is concentrating, based on the biometric information of the user. In this case, in addition to calls to the smart phone 250, if the user is working in an office at a desk, the functions of the phone 400 at the desk may also be limited. Furthermore, the emotion and concentration amount of the user may be captured when the user is at the desk or moving around, by using the ceiling camera 320 or the internal camera 254 with a wide angle lens to detect the expression of the user or movement of the face of the user, for example. In the same manner, movement of the hand of the user may be captured by the ceiling camera 320, or may be captured by the internal camera 254 having a wide angle lens.

If there is a lot of manipulation of the touch panel 252, the smart phone CPU 270 may change the setting using software such that the sensitivity of the touch panel 252 increases when the manipulation force of the touch panel 252 detected by the piezoelectric sensor 209 is large, for example. The first embodiment described above and the present modification of the first embodiment can be combined or modified and used.

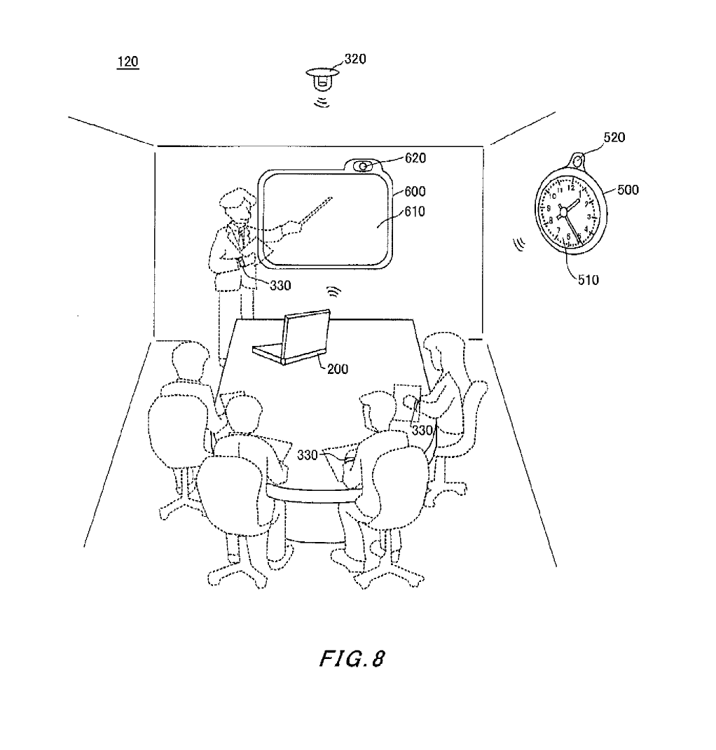

FIG. 8 shows an outline of a concentration detection system 120 according to a second embodiment. The concentration detection system 120 of the present embodiment can be configured using the same components as in the concentration detection system 110 in the first embodiment. The concentration detection system 120 of the second embodiment further adds several elements to the concentration detection system 110 of the first embodiment, as described below. In particular, the PC 200 has practically the same configuration in the present embodiment, and only further includes a function for communicating with external devices newly added to the first embodiment. Components that are the same as those in the first embodiment are given the same reference numerals, and as long as new functions have not been added, the descriptions of these components are omitted.

The concentration detection system 120 of the second embodiment is a system that provides feedback to a presenter at a presentation, meeting, lecture, or the like, by detecting the concentration amount of the participants. In contrast to the first embodiment, the target is a plurality of participants, and the concentration amount of each target is detected simultaneously or sequentially. In particular, the following describes an example of a lecture including a presenter and a plurality of attendees serving as the participants.

The concentration detection system 120 is centered on the PC 200 and includes a ceiling camera 320, biosensors 330 that are attached to the presenter and each of the attendees, a clock 500 arranged on a wall, and a screen board 600 used for the presentation by the presenter. The ceiling camera 320 arranged on the ceiling of the room is the same as the ceiling camera 320 in the concentration detection system 110, but the image capturing angle of the ceiling camera 320 is adjusted, such as by using a wide angle lens, to enable image capturing of the heads of the plurality of attendees participating in the lecture.

In the image signal output from the image capturing element of the ceiling camera 320, coordinates of pixels and positions in the lecture room are associated with each other in advance, such that the positions of the participants whose images are captured in the lecture room can be understood as coordinates. In other words, the ceiling camera 320 serves as a position sensor that detects the positions of the participants. If the lecture room is large, a plurality of the ceiling cameras 320 may be provided. In the lecture room, if it is assumed that the attendees are seated in chairs, the height of their heads is approximately 1200 mm to 1400 mm above the floor. Accordingly, the ceiling camera 320 should be adjusted to focus at this height.

The ceiling camera 320 can capture images of the hands of the attendees. The PC 200 that acquires the captured image from the ceiling camera 320 can comprehend the state of notebook PCs being manipulated or notes being taken by the attendees whose hands are resting on the tables during the lecture. If the difference between the distance from the ceiling to the heads and the distance from the ceiling to the hands is too great to fit both within the depth of field of the ceiling camera 320, the ceiling camera 320 may adopt a configuration for driving a focusing lens.

The clock 500 and the screen board 600 are arranged on a wall of the lecture room. The screen board 600 is arranged at the front of the lecture room facing the table of participants, and is used to display materials related to the presentation, for example. The clock 500 is arranged on a side wall, which is different from the front wall where the screen board 600 is arranged in front of the table of participants.

The clock 500 includes a time display section 510 that shows the time and a clock camera 520 that captures images of at least the attendees. The time display section 510 is a clock for showing the current time to the participants, and may be an analog or digital clock. The clock camera 520 is arranged near the time display section 510, with a height and angle that are adjusted to enable image capturing of all of the attendees participating in the lecture. In the same manner as the ceiling camera 320, in the image signal output from the image capturing element of the clock camera 520, coordinates of pixels and positions in the lecture room are associated with each other in advance, such that the positions of the participants whose images are captured in the lecture room can be understood as coordinates.

The screen board 600 includes a screen display section 610 and a screen camera 620. The screen display section 610 is a display section that displays material relating to the presentation. The screen display section 610 may be formed by a liquid crystal display element panel, for example, or may be formed by combining a projector and a projection screen. Instead of an electrical display apparatus, a display medium such as a white board may be used. If a non-electrical device such as a white board is used, the presentation materials are not displayed in the screen display section 610, but are instead written in marker by the presenter, for example.

The screen camera 620 is arranged near the screen display section 610, and the image capturing angle and arrangement height are adjusted to enable image capturing of all of the attendees participating in the lecture. In the same manner as the ceiling camera 320, in the image signal output from the image capturing element of the screen camera 620, coordinates of pixels and positions in the lecture room are associated with each other in advance, such that the positions of the participants whose images are captured in the lecture room can be understood as coordinates.

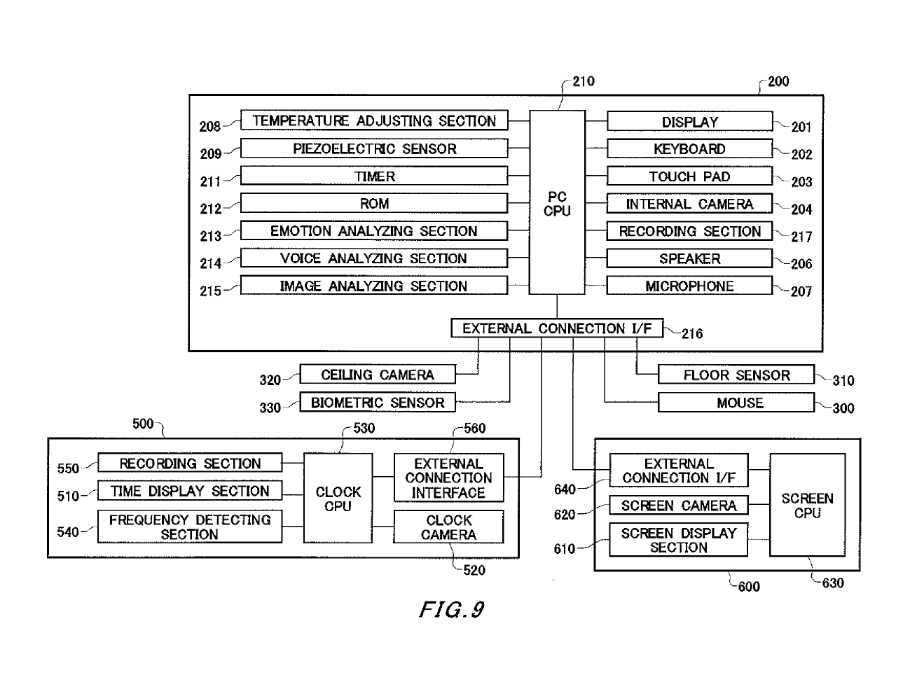

FIG. 9 is a block diagram of the concentration detection system according to the second embodiment. A recording section 217 that can record a large amount of data and is formed by an HDD or SSD, for example, is added to the PC 200. The recording section 217 records the image signal sent from each camera, and records analyzed data of the participants.

The PC CPU 210 acquires the biometric information from the biosensor 330 of each participant, while distinguishing among participants using IDs or the like, via the external connection interface 216. The PC CPU 210 acquires information from the floor sensor 310 in the same manner.

The clock 500 is centered on the clock CPU 530 and includes a time display section 510, a clock camera 520, a frequency detecting section 540, a recording section 550, and an external connection interface 560.

The clock CPU 530 performs overall control of the clock 500. The frequency detecting section 540 detects the frequency with which the attendees look at the clock 500. Specifically, the clock CPU 530 receives the image signal captured by the clock camera 520 and analyzes this signal to detect how many times each attendee has looked at the clock 500 within a predetermined unit of time. In particular, since the clock 500 is arranged on the side wall, if the gazes of the attendees are directed toward the screen display section 610, the clock camera 520 cannot capture images of the front of the faces of the attendees. Therefore, the frequency detecting section 540 uses facial recognition techniques to detect when the face of an attendee is oriented toward the time display section 510. The frequency detecting section 540 may determine that the time display section 510 is being viewed when both eyes of an attendee are detected, for example, in order to accurately recognize whether the face of the attendee is directly facing the time display section 510.

In this way, the concentration amount of each attendee can be determined. Essentially, the PC CPU 210 can determine the concentration amount of an attendee by receiving from the clock CPU 530 the frequency information detected by the frequency detecting section 540. This frequency information can include several variations. The frequency detecting section 540 can distinguish between each attendee and construct the frequency information independently for each attendee, or can construct frequency information that does not distinguish between the attendees, by counting each instance of a face being oriented toward the time display section 510 as a target of the frequency detection. With the frequency information that distinguishes between each attendee, the distribution of attendees with low concentration can be observed by creating an association with the seating position, as described further below. With the frequency information that does not distinguish between attendees, the overall concentration amount of all attendees can be easily observed.

Furthermore, the frequency detection count can be changed for a prescribed attendee. For example, if there is a target deserving of special notice, such as an important person, among the attendees, the count value is weighted in association with the seating position of this specified attendee. For example, a count value of 1.5 may be used for this person, instead of a count value of 1. As another example, counts for the other attendees may be stopped and only the count for the prescribed person may continue. By structuring the frequency information in this way, the PC CPU 210 can understand the level of interest of the important person. Even if the seating position of the specified person is a random seat that has not been predetermined, the specified person can be identified through facial recognition using the image captured by the screen camera 620.

The frequency information can take into consideration the length of continuous time during which the face of an attendee is oriented toward the time display section 510. The frequency detecting section 540 detects the continuous time during which the face is oriented toward the time display section 510 and can multiply the count value by a weighting amount when the face is oriented toward the time display section 510 continuously for a long time. In this way, the concentration amount can be more accurately expressed.

The determination concerning the concentration amount of the attendees may be performed by the clock CPU 530 instead of the PC CPU 210. In this case, the clock CPU 530 transmits to an external device, via the external connection interface 560, a control signal that controls the external device according to the concentration amount of the attendees. At this time, the determination concerning whether to transmit the control signal can take into account factors such as whether the biometric information of the attendees is to be received in advance from the PC CPU 210 and used as a condition for the concentration amount determination, for example. The specific control of the external device is described in detail further below.

The screen board 600 is centered on a screen CPU 630, and includes the screen display section 610, the screen camera 620, and an external connection interface 640.

The screen CPU 630 performs overall control of the screen board 600. As described above, the screen camera 620 can capture an image of all of the attendees participating in the lecture. In particular, since the screen camera 620 is arranged near the screen display section 610, the screen camera 620 can detect whether the face of each attendee is oriented toward the screen display section 610 by using facial recognition techniques. Here, the screen CPU 630 transmits the image signal captured by the screen camera 620 to the frequency detecting section 540 of the clock 500, via the external connection interface 640.

The frequency detecting section 540 detects how many times each attendee has looked at the screen display section 610 within a predetermined unit of time, by performing an analysis that is the same as the analysis for the image signal from the clock camera 520. Here, instead of detecting the frequency of looking at the screen display section 610, the frequency detecting section 540 may detect the focused viewing time per unit time, by measuring the continuous looking time in particular. In this way, in contrast to the case in which the clock camera 520 captures images of the attendees, it can be understood in real time how focused each attendee is on the lecture. In other words, the PC CPU 210 can determine the concentration amount of the attendees by receiving from the clock CPU 530 the focused viewing information, which includes the focused viewing time of the frequency detected by the frequency detecting section 540.

In the frequency detecting section 540, the counting process for the image signal received from the screen camera 620 is the same as the counting process for the image signal acquired from the clock camera 520. For example, it can be determined that an attendee is directly facing the screen display section 610 when both eyes of the attendee are detected, and the count values can be weighted in association with the seating positions of prescribed attendees. When identifying each attendee individually, the identification can be achieved by performing pattern matching between the captured image and a reference image of the person recorded in advance in the recording section 217.

The image signals captured by the clock camera 520 and the screen camera 620 are transmitted to the image analyzing section 215, and the image analyzing section can detect the expressions of the captured attendees by analyzing the image signals. The PC CPU 210 and the clock CPU 530 can reference the expressions of the attendees as a factor for various determinations. The image analyzing section is not limited to the PC 200, and the clock 500 and screen board 600 may be configured to include an image analyzing section.

In the present embodiment, it is assumed that the participants, including the presenter and the attendees, each wear a biosensor 330, but there are cases where it might not be appropriate to request an audience member to wear a biosensor 330, such as when customers or clients attend. Therefore, instead of a biosensor 330 that is worn, a non-contact biosensor can be user. For example, by using thermography, body temperature change of a participant can be acquired. Furthermore, biometric information may be acquired from the voice of an attendee gathered by the microphone 207. In this case, the microphone 207 is not in the PC 200, and microphones may instead be provided in the lecture room in a manner to facilitate recognition of each participant. Furthermore, a floor sensor 310 embedded in the floor may be used. Yet further, as described above, as another example of the biosensor 330, a pressure sensor and a fluid pouch may be provided in a chair on to detect biometric information of a sitting user to acquire biometric information concerning breathing, heart rate, or the like of the user.

A variety of control devices arranged within the lecture room may be connected to the concentration detection system 120. Such devices include an illumination device that adjusts the brightness, a noise cancelling apparatus that cancels out noise, and an air conditioner apparatus that adjusts the temperature in the lecture room, for example. These devices can be controlled by transmitting a control signal to the devices from the PC CPU 210. The following describes a control process.

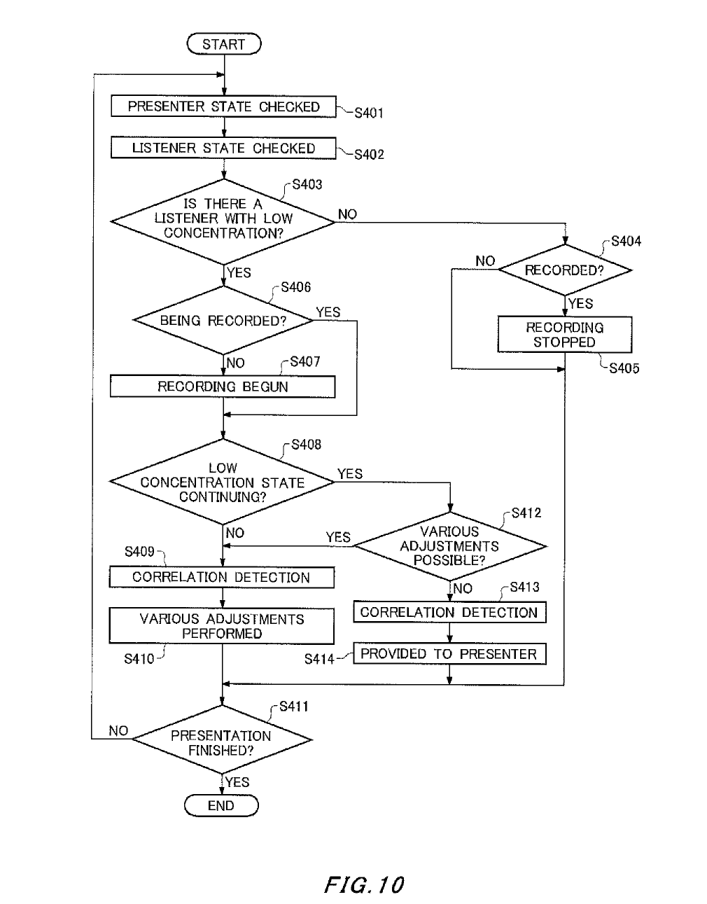

FIG. 10 is a flow chart of a process performed by the concentration detection system 120 according to the second embodiment. The process flow begins when the presented starts the presentation, for example.

At step S401, the PC CPU 210 receives image input from the internal camera 204 and the ceiling camera 320, audio input from the microphone 207, biometric information input from the biosensor 330, and the like concerning the presenter, and checks the state of the presenter. Specifically, the emotion analyzing section 213, the voice analyzing section 214, and the image analyzing section 215 analyze the input information, and the PC CPU 210 determines whether the presenter is nervous or relaxed.

The PC CPU 210 proceeds to step S402, and checks the states of the attendees. In particular, the PC CPU 210 checks the concentration amount of the attendees based on the various types of input information. The PC CPU 210 receives the image signal from the ceiling camera 320, determines if there are any attendees exhibiting a large amount of head movement, and if there is such an attendee, detects the seating position of this attendee. Furthermore, as described above, the PC CPU 210 acquires, for each attendee, information indicating the frequency of looking at the time display section 510 from the image acquired from the clock camera 520 and information indicating the frequency of looking at the screen display section 610 from the image acquired by the screen camera 620.

The presentation material video of the presenter displayed in the screen display section 610 is provided by an image signal transmitted from the PC CPU 210. Accordingly, the PC CPU 210 can determine whether an attendee has turned the page of paper material in front of them, based on the image signal from the ceiling camera 320, in synchronization with the timing at which a page of the presentation material is switched by a manipulation of the PC 200 by the presenter. If the attendees turn the pages of the paper materials at the proper timing, it can be determined that the attendees are focusing on the lecture. On the other hand, if the hands of the attendees cannot be detected on the table or if page turning cannot be continued, there is a high probability that the attendees are not concentrating. If an attendee turns a page within five seconds, for example, from when the presenter has moved to the next page, the PC CPU 210 determines that this attendee is concentrating. Furthermore, instead of using synchronization with the page switching by the presenter, the PC CPU 210 can periodically check the concentration amount of the attendees by determining that an attendee is taking notes when a hand of the attendee moves above the table, for example.

The concentration amount of the attendees is collected from various types of information as described above, and is determined as a total. For example, the PC CPU 210 can acquire a concentration amount evaluation value for each type of information by putting each type of collected information into a look-up table stored in the ROM 212, and determine that the attendees are concentrating if these integrated values exceed a predetermined threshold. Furthermore, even if these values are under the threshold, it can be understood how low the concentration is based on the amount of these integrated values.

After checking the state of the attendees, the PC CPU 210 proceeds to step S403 and determines whether there is an attendee with low concentration. Here, the concentration value used as the threshold can be set according to an amount occurring when the attendees are not concentrating, as described above. For example, considering that there is a natural drop in concentration at the time when the end of the lecture is reached, the concentration amount set as the threshold may be lowered significantly below the amount at the start of the lecture.

If there is an attendee with low concentration, the PC CPU 210 proceeds to step S406. At step S406, the PC CPU 210 checks whether recording of at least one of the image signal from the internal camera 204 or the like and the audio signal from the microphone 207 has already begun. In other words, the PC CPU 210 checks whether the video or audio of the presenter is currently being recorded. The lecture is recorded in this way so that attendees who did not concentrate can receive the lecture again later. The PC CPU 210 proceeds to step S407 if recording is not in progress, begins the recording, and then proceeds to step S408. If recording is already in progress, the PC CPU 210 skips step S407 and proceeds to step S408.

At step S403, if there are no attendees with low concentration, the PC CPU 210 proceeds to step S404. At step S404, in the same manner as step S406, the PC CPU 210 checks whether recording is in progress. In this case, it is determines that the attendees are concentrating, and therefore it is not necessary to record the lecture for later use. Accordingly, the PC CPU 210 proceeds to step S405 if recording is in progress, stops the recording, and then proceeds to step S411. If recording is not in progress, the PC CPU 210 proceeds to step S411.

At step S408, the PC CPU 210 determines whether the low concentration of the attendee is continuing. In other words, the PC CPU 210 determines whether there is an attendee who still has low concentration even after a prescribed time has passed from the previous determination.

When it is first determined that an attendee has low concentration or when it is again determined that concentration is low after the concentration amount had temporarily recovered (the “NO” in the process flow), the PC CPU 210 proceeds to step S409.

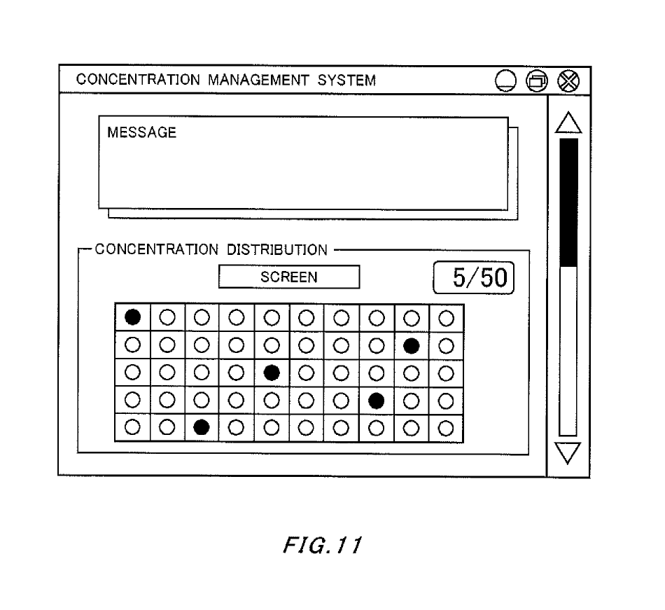

At step S409, the PC CPU 210 detects the correlation between attendees with low concentration and the seating positions of these attendees. As shown in FIG. 11, this correlation relationship is shown in a management window displayed in the display 201, where attendees with low concentration and the seating positions of the attendees are shown graphically as a concentration distribution. In FIG. 11, the white circles represent a group of attendees with high concentration, and the black circles represent a group of attendees with low concentration. In the screen, the number of attendees with low concentration and the total number of attendees are displayed as numerals. In the state shown in FIG. 11, no trend is seen for the seating positions of the attendees with low concentration, and the PC CPU 210 determines that there is no correlation relationship among the attendees with low concentration.

The PC CPU 210 proceeds to step S410, and performs various adjustments. For example, if the overall number of attendees with low concentration in the lecture room is greater than a threshold and there is determined to be no correlation relationship with the seating positions, the PC CPU 210 transmits a control signal for raising or lowering the temperature to the air conditioning device, to adjust the temperature. For example, if attendees at the end of the room closer to the hall seem to have lower concentration, the PC CPU 210 cancels out noise by transmitting, to a noise cancelling apparatus that cancels output noise from the hall, a control signal that causes the noise cancelling apparatus to output sound waves with inverse phases relative to the noise. As another example, if there is a lot of head movement and it seems that an attendee might be nodding off, the PC CPU 210 transmits a control signal for increasing brightness to an illumination device, thereby making the lecture room brighter.

The PC CPU 210 proceeds to step S411, and determines whether the lecture has finished. The PC CPU 210 returns to step S401 if it is determined that the lecture is not finished, and the series of processes is ended if it is determined that the lecture is finished.

At step S408, if it is determined that the concentration of the attendees is continuously low (the “YES” in the process flow), the PC CPU 210 proceeds to step S412. Here, continuously low concentration refers to a case in which, for example, it is determined that a predetermined number of specified people have had continuously low concentration. As another example, this may refer to a case in which, although the specified attendees have not had low concentration, one of the important attendees has had continuously low concentration.

At step S412, in the same manner as in step S410, the PC CPU 210 determines whether there is an adjustable device that can change the environment of the lecture room. The PC CPU 210 proceeds to step S409 if there is such a device, and proceeds to step S413 if there is no such device.

Upon proceeding to step S413, it is assumed that the drop in concentration of the attendees is caused by the presentation of the presenter, and not the environment, and a request is made to the presenter. First, at step S413, in the same manner as step S409, the PC CPU 210 detects the correlation between the attendees with low concentration and the seating positions of these attendees. In the present embodiment, the correlation detection of steps S409 and S413 is performed after the determination of step S408, but this correlation detection may be performed before the determination of step S408 instead.

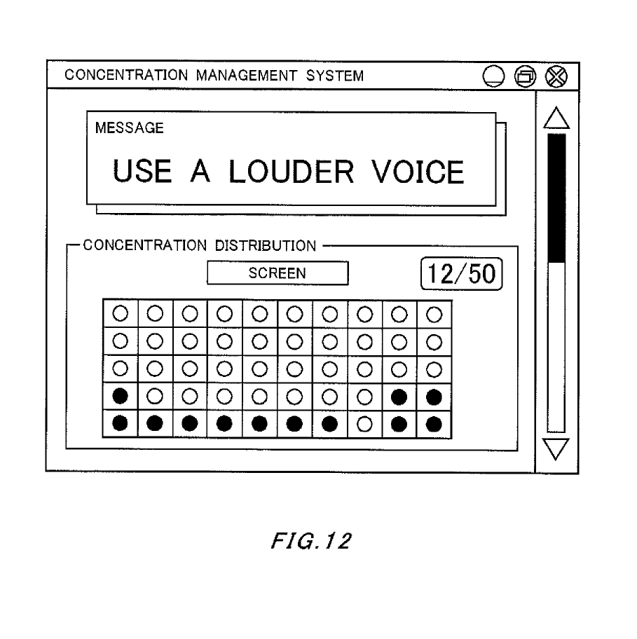

When a correlation is detected, the PC CPU 210 proceeds to step S414 and issues instructions to the presenter. For example, as shown in FIG. 12, when a correlation is found indicating that the attendees with low concentration are focused in the seats at the back of the lecture room, the PC CPU 210 displays a message of “use a louder voice” in the management window displayed in the display 201. As another example, the PC CPU 210 may transmit to the screen board 600 a control signal that increases the size of the presentation materials displayed in the screen display section 610.

At this time, the state of the presenter determined at step S401 can be utilized. For example, if it was determined that the presenter was feeling nervous, the PC CPU 210 displays this fact in the display 201, so that the presenter can be objectively aware of the nervousness. Of course, information relating to the detected expression may also be displayed. Furthermore, the order of the presented materials may be changed to ease the nervousness, or materials for generating discussion may be transmitted to the screen display section 610. Yet further, an animation process can be changed, or detailed materials can be displayed.

The PC CPU 210 can detect the speaking speed and, if it is determined that the speaking speed is faster than a threshold, the PC CPU 210 can display a message such as “speak more slowly” to the user in the display 201.

When the instructions to the user at step S414 are finished, the PC CPU 210 proceeds to step S411 and checks whether the lecture is finished. If it is determined that the lecture is finished, the series of processes is ended. Step S414 described above may be performed after the various adjustments of step S410 are performed.

In the process flow described above, the attendees with low concentration at the current time are detected, but instead, an increase or decrease in the number of attendees with low concentration can be used as the standard for determination. In other words, the determination standard can be whether the number of attendees with low concentration has increased suddenly between two concentration detections performed at different times, and also what the correlation between these attendees and their seating positions is.

In the above process flow, attendees are grouped based on high concentration or low concentration, but can instead be grouped according to emotional states detected from the biometric information. For example, the PC CPU 210 may perform various processes according to a distribution of attendees that feel irritated. As another example, the PC CPU 210 can perform the various processes by using both the concentration amount and the emotional state.

In the above process flow, a lecture was used as an example, but the application range of the concentration detection system 120 is not limited to this. For example, by applying the concentration detection system 120 in a workplace, a supervisor can recognize stress in employees based on the biometric information, and can prevent a decrease in workplace morale by reassigning tasks or talking to the employees. Furthermore, when applied in a classroom, learning can be improved by recognizing items that a student does not understand.

In the above embodiment, one problem to be solved is that, conventionally, no one has focused on the fact that a user who is concentrating on work is distracted by a bidirectional communication device serving as a communication tool. To solve this problem, provided is an electronic device comprising an input section that inputs biometric information, which is information relating to a living body of a user, and an output section that outputs a limit signal limiting contact with the user to the bidirectional communication device, based on the biometric information, for example.

Furthermore, in the prior art, there is a problem that support for a user is limited to only the user of the device, and that the user and device have a one-to-one relationship, which lacks the possibility of expansion. To solve this problem, provided is an electronic device comprising a biometric information input section that inputs biometric information, which is information relating to living bodies of a plurality of human targets, and an output section that outputs a control signal for controlling a device to be controlled to the device to be controlled, based on the biometric information, for example.

Another problem to be solved is that there has been no discussion about a specific means for detecting concentration amount of a user by focusing on specific actions of the user. To solve this problem, provided is an electronic device comprising a time display section that displays time, a first image capturing section that is provided near the time display section, and a first detecting section that detects a frequency with which a face of at least one human target is oriented toward the time display section, based on an image captured by the first image capturing section, for example.

Another problem to be solved is that there has been no attention paid to control of a device that takes into consideration the manipulation state through which the user manipulates a manipulation section. To solve this problem, provided is an electronic device comprising an input section that inputs biometric information, which is information relating to a living body of a user, a manipulation section that receives input manipulation of the user, a detecting section that detects a manipulation state of the manipulation section resulting from manipulation by the user, and a changing section that changes a setting, based on the manipulation state and change in the biometric information, for example.

Another problem to be solved is that it is difficult to increase the manipulation sensitivity of a device while predicting manipulation of the device by the user. To solve this problem, provided is an electronic device comprising a manipulation section that receives input manipulation of a user, an image input section that inputs an image from an image capturing apparatus capturing at least a portion of the manipulation section and at least a portion of a hand of the user, and a changing section that changes a setting based on position information of the hand acquired by analyzing the image, for example.

Another problem to be solved is that a control device using only biometric information is insufficient, and there is a desire that other information be used as well. To solve this problem, provided is an electronic device comprising an expression detecting section that detects an expression of a target, a biometric information input section that inputs biometric information, which is information relating to a living body of the target, and a control section that controls a device to be controlled, based on the biometric information and a detection result of the expression detecting section, for example.

Another problem to be solved is that it is difficult to make a device understand the emotional state of the user before a change of the user is expressed as biometric information, or to have the device more accurately understand the emotional state of the user when the change is expressed. To solve this problem, provided is an electronic device comprising a speaking speed detecting section that detects speaking speed of a target, and a control section that controls a device to be controlled, based on a detection result of the speaking speed detecting section, for example.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### LIST OF REFERENCE NUMERALS

110: concentration detection system, 120: concentration detection system, 200: PC, 201: display, 202: keyboard, 203: touch pad, 204: internal camera, 205: ultrasonic sensor, 206: speaker, 207: microphone, 208: temperature adjusting section, 209: piezoelectric sensor, 210: PC CPU, 211: timer, 212: ROM, 213: emotion analyzing section, 214: voice analyzing section, 215: image analyzing section, 216: external connection interface, 217: recording section, 250: smart phone, 251: display, 252: touch panel, 254: internal camera, 257: microphone, 260: biosensor, 270: smart phone CPU, 300: mouse, 310: floor sensor, 320: ceiling camera, 330: biosensor, 400: phone, 410: indicator light, 500: clock, 510: time display section, 520: clock camera, 530: clock CPU, 540: frequency detecting section, 550: recording section, 560: external connection interface, 600: screen board, 610: screen display section, 620: screen camera, 630: screen CPU, 640: external connection interface

What is claimed is:

1. An electronic device, comprising:
a receiver that receives an operation;
a detector that detects a force to the receiver while the receiver receives the operation; and
a controller that performs a process according to the operation received by the receiver and controls the process based on the force detected by detector.

2. The electronic device as set forth in claim 1, wherein:
the controller performs different processes according to the force detected by the detector.

3. The electronic device as set forth in claim 1, further comprising:
a display that displays an image, wherein:
the controller displays on the display that different processes have been performed when different processes have been performed.

4. The electronic device as set forth in claim 1, further comprising:
a display that displays an image, wherein:
the controller displays different images on the display based on the force detected by the detector.

5. The electronic device as set forth in claim 4, wherein:
the controller displays the images in different sizes based on the force detected by the detector.

6. The electronic device as set forth in claim 4, wherein:
the images are characters, drawings, or icons.

7. The electronic device as set forth in claim 1, further comprising:
a communication device that communicates with an external device, wherein
the controller performs different processes to the communication device based on the force detected by the detector.

8. The electronic device as set forth in claim 1, wherein:
the receiver is a touch panel, and
the detector detects a force to a display surface of the touch panel.

9. The electronic device as set forth in claim 1, further comprising:
an imager configured to capture images, wherein:
the controller performs different processes based on the force detected by the detector and an image captured by the imager.

10. The electronic device as set forth in claim 9, wherein:
the imager images a direction crossing a plane in which the receiver is arranged.

11. The electronic device as set forth in claim 1, further comprising:
an input to which biometric information is input, wherein:
the controller performs different processes, based on (i) the force detected by the detector and (ii) an image captured by an imager configured to capture images or the biometric information input to the input.
